(19) United States
(12) Patent Application Publication
(10) Pub. No.: US 2015/0212575 A1
(43) Pub. Date: Jul. 30, 2015

(54) APPARATUS AND METHOD FOR PERFORMING OUTPUT CONTROL ACCORDING TO ENVIRONMENT IN ELECTRONIC DEVICE

(71) Applicant: Samsung Electronics Co., Ltd., Gyeonggi-do (KR)

(72) Inventors: Kwan-Woo SONG, Gyeonggi-do (KR); Kyung-Jae Kim, Gyeonggi-do (KR)

(73) Assignee: Samsung Electronics Co., Ltd.

(21) Appl. No.: 14/604,908

(22) Filed: Jan. 26, 2015

(30) Foreign Application Priority Data
Jan. 24, 2014 (KR) 10-2014-0009134

(51) Int. Cl. G06F 3/00; G09G 5/10; G06F 3/16

(52) U.S. Cl. CPC G06F 3/005; G06F 3/167; G09G 5/10; G09G 2320/0626; G09G 2360/144

(57) ABSTRACT

An apparatus for controlling an electronic device is provided. The apparatus includes a detecting unit for detecting whether a user is sleeping and identifying the user; a control unit for controlling an output according to at least one of whether the user is sleeping, an identification of the user, and environment information; and an output unit for outputting an image according to a value controlled by the control unit.

### PRIORITY

This application claims priority under 35 U.S.C. §119 to a Korean Patent Application filed in the Korean Intellectual Property Office on Jan. 24, 2014 and assigned Serial No. 10-2014-0009134, the contents of which are incorporated herein by reference.

### BACKGROUND OF THE INVENTION

1. Field of the Invention

The present invention generally relates to an electronic device for outputting an image and a sound.

2. Description of the Related Art

The term “smart home” refers to a residence which interworks with various devices, such as home appliances and sensors to provide in-residence convenience and effectiveness to a user. Among those devices, a smart television (TV) functions as a hub as a central device in residence, controls various home appliances, and provides services through the TV. However, the services are provided only when the user watches the TV.

When lighting is embedded in a bezel of the TV in order to allow the TV to function as auxiliary lighting, such as a lighting stand in the related art, the size of the bezel of the TV increases. Also, the lighting of the bezel may function as romantic lighting but the lighting function thereof is not good. In the case of using an LED panel itself as lighting, since the TV is generally located at a position where the user watches the TV conveniently, the lighting using the LED panel causes glare, due to the direct light, thereby making it hard to provide a good service for the user.

### SUMMARY OF THE INVENTION

The present invention has been made to address at least the above-mentioned problems and/or disadvantages and to provide at least the advantages described below.

Accordingly, an aspect of the present invention provides an apparatus and method for determining a user state in an electronic device.

Another aspect of the present invention provides an apparatus and method for controlling a function according to a user state in an electronic device.

Another aspect of the present invention provides an apparatus and method for performing a lighting function in an electronic device when a user approaches the electronic device.

Another aspect of the present invention provides an apparatus and method for identifying a user in an electronic device.

Another aspect of the present invention provides an apparatus and method providing pieces of different information according to users in an electronic device.

Another aspect of the present invention provides a method for allowing the TV to function as auxiliary lighting, such as a lighting stand, or to transfer information to increase availability of the TV, when there is an increasing demand for a light emitting diode (LED) panel-based smart TV.

According to an aspect of the present invention, an electronic device includes an output unit configured to output contents; and a control unit configured to control the output of the contents based on at least one of a user state and an environment state.

According to another aspect of the present invention, a method for an electronic device includes controlling an output of contents based on at least one of a user state and an environment state; and outputting the contents.

According to another aspect of the present invention, an apparatus for performing output control according to a user state includes a detecting unit configured to detect a user state and an environment state; a control unit configured to determine output contents based on at least one of the user state and the environment state; and an output unit configured to output at least one of an image or a sound according to the output contents.

According to another aspect of the present invention, a method for performing output control according to a user state includes detecting a user state and an environment state; determining output contents based on at least one of the user state and the environment state; and performing output control to output at least one of an image or a sound according to the output contents.

### BRIEF DESCRIPTION OF THE DRAWINGS

The above and other aspects, features and advantages of the present invention will be more apparent from the following detailed description, taken in conjunction with the accompanying drawings, in which:

FIG. 1 illustrates a configuration of an electronic device according to an embodiment of the present invention;

FIG. 2 illustrates a process of performing output control according to a user state in an electronic device according to an embodiment of the present invention;

FIG. 3 illustrates a procedure of operations of an electronic device according to detection of a user's motion according to an embodiment of the present invention;

FIG. 4 illustrates a process of controlling a panel according to detection of waking up of a user in an electronic device according to an embodiment of the present invention;

FIG. 5 illustrates a procedure of operations of an electronic device according to an identification of a user according to an embodiment of the present invention;

FIG. 6 illustrates a process of controlling a panel according to detection of a user in an electronic device according to an embodiment of the present invention;

FIG. 7 illustrates a procedure of operations of an electronic device according to whether a user is sleeping according to an embodiment of the present invention;

FIG. 8 illustrates a process of controlling a panel and a sound according to detection of sleeping of a user in an electronic device according to an embodiment of the present invention; and

FIG. 9 is a block configuration of an apparatus for performing output control in an electronic device according to an embodiment of the present invention.

### DETAILED DESCRIPTION OF EMBODIMENTS OF THE PRESENT INVENTION

The present invention will be described herein below with reference to the accompanying drawings. In the following description, detailed descriptions of well-known functions or configurations will be omitted since they would unnecessarily obscure the subject matter of the present invention. Also, the terms used herein are defined according to the functions of the present invention. Thus, the terms may vary depending on users' or operators' intentions or practices. Therefore, the terms used herein should be understood based on the descriptions made herein.

Hereinafter, a description will be given of a technology for performing output control according to a user in an electronic device. Methods according to embodiments described in the claims or specification of the present invention may be implemented in an electronic device which outputs an image. The electronic device according to an embodiment of the present invention may include a television (TV), a monitor, a mobile phone, and other devices capable of outputting an image.

Hereinafter, a user state refers to at least one of a motionless state of a person or object, a movement of a person or object (including a user's motion and a movement of a part of the user's body), a sound of a user, or a sound due to a movement of a user. The user state may further refer to a state of a user that is determined or identified by a combination of the above-described user states, such as a sleep state of a user, or a wake-up state of a user.

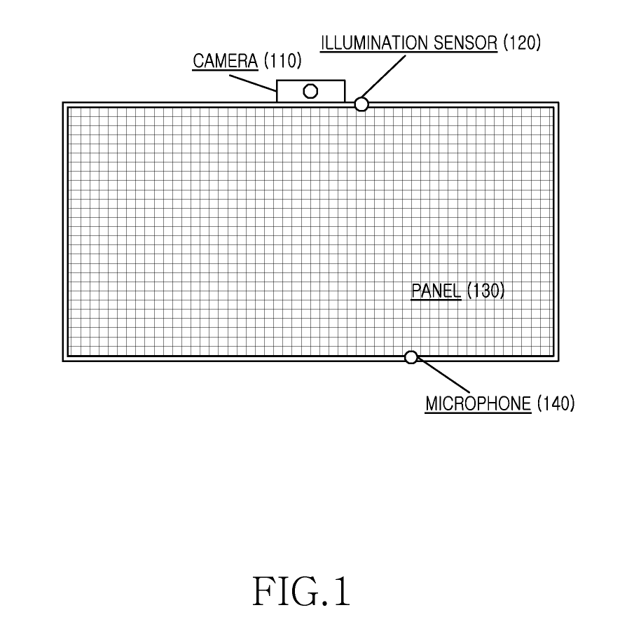

FIG. 1 illustrates a configuration of an electronic device according to an embodiment of the present invention.

Referring to FIG. 1, the electronic device includes a camera 110, an illumination sensor 120, a panel 130, and a microphone (mic) 140.

The electronic device detects a user state through the camera 110. The user state is information required to perform control according to the user state by the electronic device. Specifically, when image information is acquired through the camera 110, the electronic device analyzes the image information acquired from the camera and detects a motionless state of a person or object, or a movement of a person or object. Also, the electronic device may analyze the image information acquired from the camera to identify a user based on pre-registered user face information.

The electronic device detects an ambient brightness through the illumination sensor 120. Specifically, when the ambient brightness (illumination) is detected through the illumination sensor 120, it is possible to control brightness so as to be suitable for a user's situation based on the illumination detected by the illumination sensor 120.

The electronic device displays a screen and provides a lighting function, through the panel 130. Specifically, the electronic device controls a back light unit (BLU) of the panel through a panel control module to adjust dimness of the panel, and control dimness for a desired region in grids of the panel. That is, it is possible to perform control such that a portion of the panel is bright and the remaining region is not used.

The electronic device detects a sound through the microphone 140. Specifically, when acquiring external voice information from the microphone, the electronic device analyzes the sound acquired from the microphone through a sound detecting module to identify the user's footstep sound, a child crying sound, a sound of door opening, or the like.

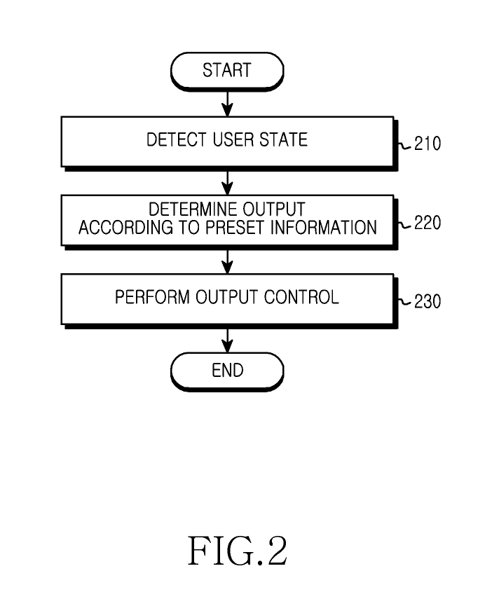

FIG. 2 illustrates a process of performing output control according to a user state in an electronic device according to an embodiment of the present invention.

In step 210, the electronic device detects a user state and an environment state. The user state is a reference based on which the electronic device determines whether to start the process of performing output control according to the embodiment of the present invention. The user state may be detected through at least one of a camera and a microphone of the electronic device. The environment state includes information about an environment situation, such as the current time, a current illumination, weather at the current time or a specific time, news, and the like.

In step 220, the electronic device determines a control according to a previously-input operation condition (e.g., a preset reference). In other words, the electronic device determines output contents (control value) according to whether the previously-input operation condition is satisfied under the user state detected in step 210. The output contents indicate which function of one or more functions equipped in the electronic device is activated and how to perform the activated function. Specifically, when the preset reference is satisfied based on at least one of the pieces of information collected in step 210, the electronic device may determine an output. In this case, the preset reference may be set by the user.

In step 230, the electronic device controls the electronic device according to a result of the determination in step 220. Specifically, the electronic device controls a brightness of a screen, display information suitable for the user, or cut off power to the electronic device, according to a result of the determination in step 220.

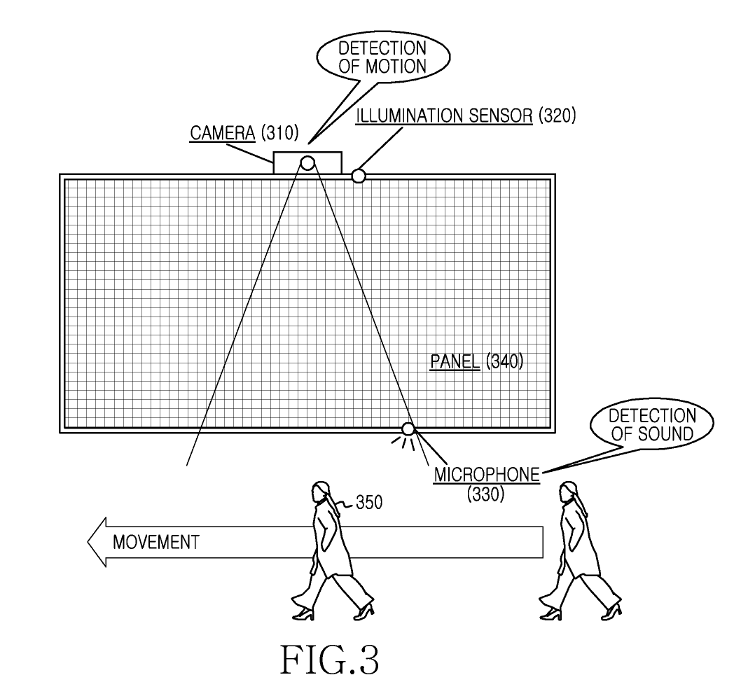

FIG. 3 illustrates a procedure of operations of an electronic device according to detection of a user's motion according to an embodiment of the present invention.

When the electronic device is in a standby mode when a screen is turned off, the electronic device detects a motion of a user 350 through the camera 310 or detects a sound due to the motion through the microphone 330, and provides a lighting function to the user 350. For example, when the user 350 passes in front of the electronic device, the electronic device detects the movement of the user 350 through the camera 310 and detects a sound through the microphone 320 to turn on the panel 340, thereby operating in a lighting mode. The lighting mode may be used to provide a lighting function to the user without disturbing the sleep of other persons mainly at night.

Determining whether to operate, an operation reference, and an operation level may be changed according to settings of the user. For example, the illumination sensor 320 detects an ambient brightness to allow the electronic device to operate only when the surroundings thereof get dark. Also, it may be possible to allow the electronic device to operate in a specific time, or to allow the electronic device not to operate when the user wants to allow the electronic device not to operate. The operation reference may be set as a insensitive setting by the user. Also, the electronic device may automatically adjust brightness of a screen in consideration of an ambient illumination, or the brightness may be adjusted according to an illumination previously set by the user.

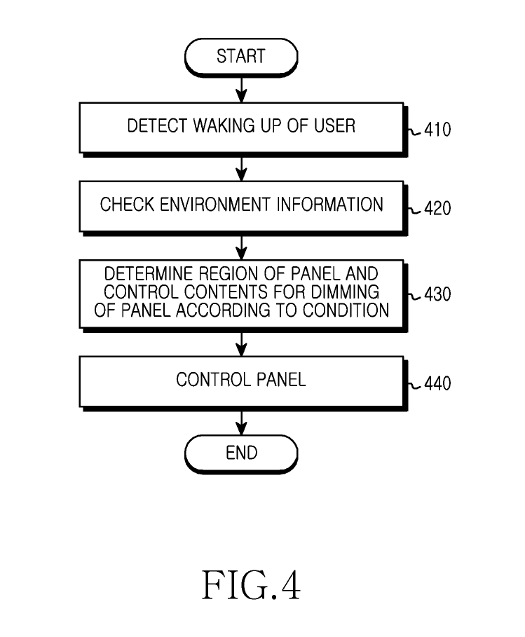

FIG. 4 illustrates a process of controlling a panel according to detection of waking up of a user in an electronic device according to an embodiment of the present invention.

In step 410, the electronic device detects a motion and a sound of the user. The electronic device detects the motion of the user through the camera and detects the sound emanating from the user through the microphone. The electronic device determines whether the user wakes up based on at least one of the detected motion and the detected sound. When at least one of the motion and the sound satisfies a predefined condition, the electronic device determines that the user wakes up. For example, when the motion of the user is detected and the amplitude of the motion is larger than a threshold value, or when the sound emanating from the user is detected and the magnitude of the sound satisfies a preset reference, the electronic device may determine that the user wakes up.

In step 420, the electronic device checks, or collects environment state information required for control. The environment state information required for control includes the intensity of an illumination of an ambient environment, the current time, or preset information. In this case, the preset information may be set by the user.

In step 430, the electronic device determines a region of a panel and output contents for a dimming of the panel according to a condition. When it is determined to activate the lighting mode based on the information acquired in steps 410 and 420, it is possible to select an on-region of the panel and a dimming value corresponding to the preset information. The condition may be a dimming which is small enough not to disturb sleep of other persons, for example, a dimming of 10% to 20%, or a dimming which is not too large, which may vary depending on a value set by the user. It is possible to turn on only a portion of the panel to implement lighting wanted by the user, in addition to the dimming.

In step 440, the electronic device controls the panel. The electronic device may control the panel to have an appropriate dimming, or allow only a portion of the panel to be turned on according to a result of the determination of step 430.

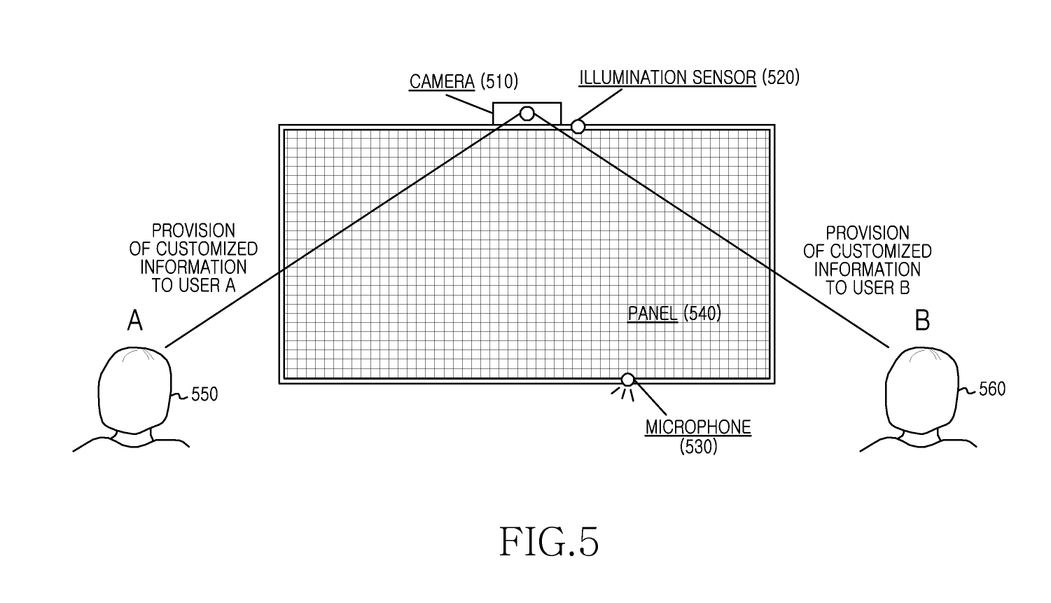

FIG. 5 illustrates a procedure of operation of an electronic device according to identification of a user according to an embodiment of the present invention.

The electronic device identifies faces of a user A 550 and a user B 560 through a camera 510, detects voices of the user A 550 and the user B 560 through a microphone 530, or identifies the user A 550 and the user B 560 based on user information directly input by the user A 550 and the user B 560. The electronic device provides information through a panel 540 according to the user A 550 and the user B 560 based on information of the identified user A 550 and user B 560. For example, it is possible to provide, through a screen, information, such as schedules of the user A 550 and the user B 560, an alarm time point, or a time until the alarm time point, weather at the current time or a designated date, or news.

Referring to FIG. 5, when the electronic device detects the face of the user A 550 through the camera 510 or detects the voice of the user A 550 through the microphone, the electronic device compares face information or voice information with previously-input data of the user A 550, and when the face information or the voice information is identical to the previously-input data of the user A 550, identifies the user A 550. Thereafter, the electronic device provides information necessary for the user A 550 according to setting information previously set by the user A 550. The electronic device operates with respect to the user B 560 in a similar manner as the user A 550.

Determining whether to operate, an operation reference, and an operation level may be changed according to settings of the user. The information may be provided through the whole portion or a designated portion of the screen. A type and contents of the information, a cycle in which the information is provided, and the like may be changed according to the settings of the user.

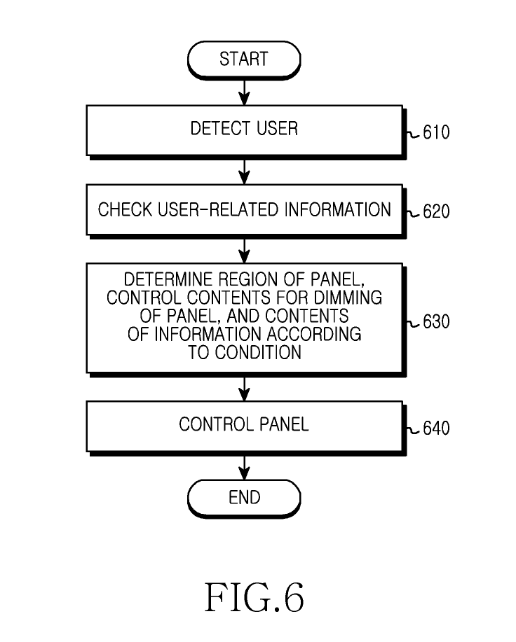

FIG. 6 illustrates a process of controlling a panel according to detection of a user in an electronic device according to an embodiment of the present invention.

In step 610, the electronic device detects a user. The electronic device detects the user's face through a camera and detects the user's voice through a microphone. Specifically, the electronic device determines whether user face information detected through the camera or user voice information detected through the microphone is identical to previously-input user information. When the detected user information is identical to the previously-input user information, the electronic device identifies the user.

In step 620, the electronic device checks user-related information for the user detected in step 610. For example, the electronic device may check the user's schedule, an alarm time point, or a time until the alarm time point, or the like, and collect information on environment, such as the current weather, news, or the like. These pieces of information are used to provide information to the user.

In step 630, the electronic device determines a control according to a condition. The electronic device determines which information is to be provided to the user based on the environment information, a variety of setting information, or the like acquired in step 620. For example, it is possible to select the whole portion or a portion of the panel of the electronic device which is designated by the user, to select provision of the user's schedule information, time information until an alarm time point, weather information at the current time, the next day, or a designated time, through the panel, or to select news information or the like.

In step 640, the electronic device controls the panel. The electronic device displays information selected according to a condition in step 630 on the whole portion or a designated portion of the panel. The electronic device configures a screen representing the selected information and displays the screen through the panel.

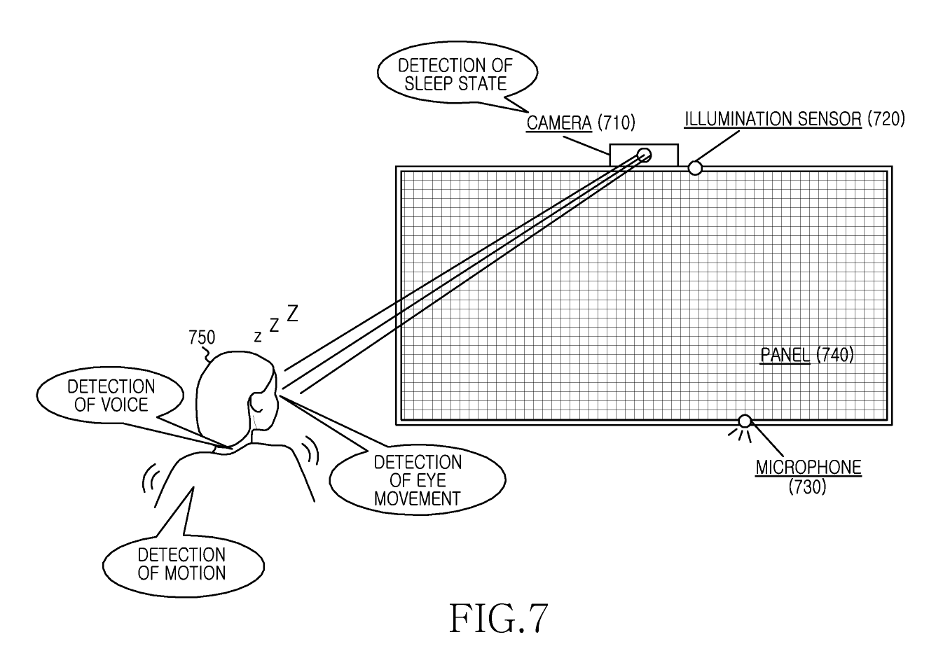

FIG. 7 illustrates a procedure of operation of an electronic device according to whether a user is sleeping according to an embodiment of the present invention.

When a user 750 watches the electronic device in a state in which a screen of the electronic device is turned on, the electronic device detects a motion of the user 750 through a camera 710, or detects a sound due to the motion through a microphone 730 and provides a sleep inducing mode to the user 750.

The electronic device detects a face or motion of the user 750 through the camera 710 and detects a voice of the user 750 through the microphone 730 to provide a sleep inducing mode or a sleep preventing mode to the user 750. Specifically, the electronic device detects the face or motion of the user through the camera 710 to detect the user's eye movement or the amplitude of the user's motion, and detects the user's voice through the microphone 730 to detect the amount of noise, or a specific sound, such as a snoring sound, thereby determining whether the user is sleeping. In the sleep inducing mode, when it is determined that the user is sleeping, the electronic device adjusts a panel 740 brightness down or turns off a power supply of the electronic device. In the sleep preventing mode, when it is determined that the user is sleeping, the electronic device may make the user wake up from sleep by using a method for adjusting the panel 740 brightness up, a method for displaying a glittering effect, a method for increasing a volume, or the like.

Determining whether to operate, an operation reference, and an operation level may be changed according to settings of the user. A reference based on which the electronic device determines whether the user is sleeping may include the amplitude of the user's motion, the user's eye movement, ambient voice information, or the like.

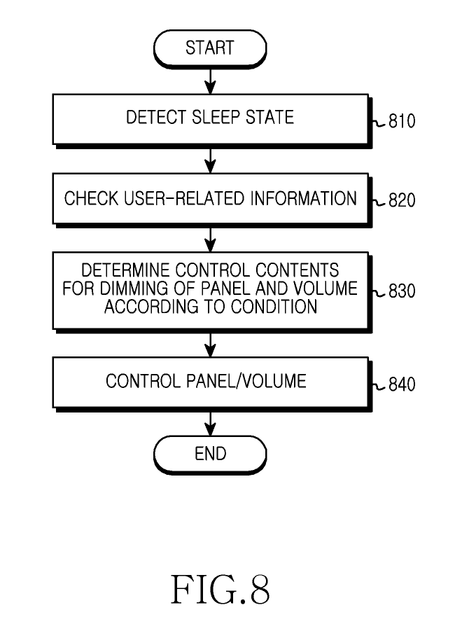

FIG. 8 illustrates a process of controlling a panel and a sound according to a user's sleep state in an electronic device according to an embodiment of the present invention.

In step 810, the electronic device detects a user's sleep state. The electronic device detects the user's face or motion by using a camera, or detects the user's voice by using a microphone. Specifically, when a change in the user's face, a change in the user's eye movement, or the amount of the user's body movement, which is acquired as described above, satisfies a preset value, the electronic device determines that the user is sleeping. Also, when the amount of sound emanating from the user satisfies a preset value, or when a specific sound, such as a snoring sound, is matched with a preset sound, the electronic device determines that the user is sleeping.

In step 820, the electronic device checks user-related information. The user-related information includes the current time, a current illumination, a mode of the electronic device set by the user, or the like.

In step 830, the electronic device determines output contents for a dimming of a panel and a sound according to a condition. When it is determined that the user is sleeping, the electronic device determines a control according to preset information. The preset information indicates provision of a sleep inducing mode for inducing the user to sleep, or provision of a sleep preventing mode for inducing the user to wake up, when it is determined that the user is sleeping. For example, in a case where the user sets the sleep preventing mode, when it is determined that the user is sleeping, the electronic device determines information for allowing the user to wake up from sleep, such as a method for increasing the brightness of the panel, a method for displaying a glittering effect, or a method for increasing a volume of the electronic device. On the contrary, in a case where the user sets the sleep inducing mode, when it is determined that the user is sleeping, the electronic device may determine information, such as a method for reducing the brightness of the panel, a method for reducing a volume, or a method for cutting off power to the electronic device.

In step 840, the electronic device controls the panel and the sound. In step 830, when being in the sleep preventing mode, the electronic device increases the screen brightness, displays the glittering effect, or increases the volume of the electronic device. Also, when being in the sleep inducing mode, the electronic device reduces the screen brightness, reduces the volume of the electronic device, or cuts off power to the electronic device.

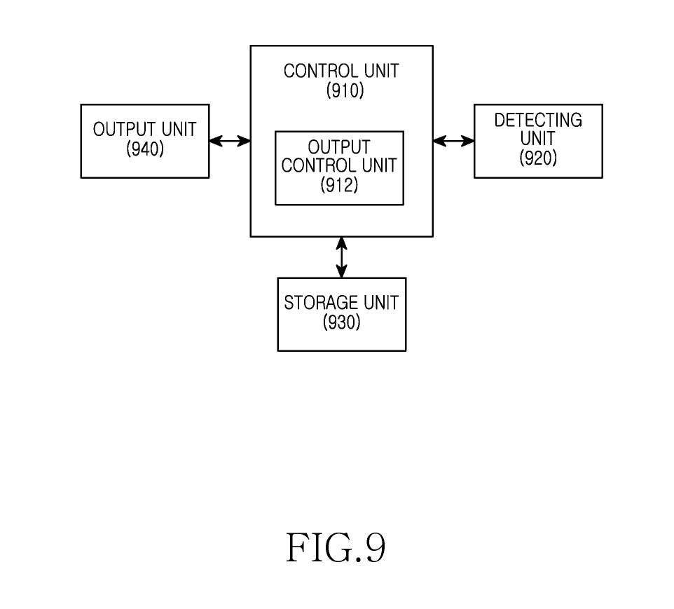

FIG. 9 illustrates a block configuration of an apparatus for performing output control in an electronic device according to an embodiment of the present invention.

Referring to FIG. 9, the electronic device includes a control unit 910, an output control unit 912, a detecting unit 920, a storage unit 930, and an output unit 940.

The control unit 910 controls and processes overall operation of the electronic device, and performs a function for controlling the electronic device based on data which is previously set or is detected by the detecting unit 920.

The detecting unit 920 includes an operation detecting module, a sound detecting module, a user identifying module, and an illumination detecting module. The operation detecting module analyzes images received from a camera detects a motionless state of a person or object, or detects movement of a person or object. The sound detecting module analyzes a sound received from a microphone and identifies a user's footstep sound, a child crying sound, a sound of door opening, and the like. The user identifying module analyzes the images received from the camera to identify the user based on pre-registered user face information. The user identifying module also analyzes the sounds received from the microphone to identify the user based on pre-registered user sound information. The illumination detecting module detects an ambient brightness (illumination) and provides a brightness value suitable for the user's situation. In another embodiment of the present invention, the detecting unit 920 may include a motion detecting module, a sound detecting module, a user identifying module, and an illumination detecting module. The motion detecting module detects a motionless state of a person or object, or movement of a person or object.

The storage unit 930 stores a variety of programs and data for operation of the electronic device. In particular, the storage unit 930 may store programs required to output a variety of information acquired by the detecting unit 920 to the output unit 940.

The output unit 940 outputs a variety of state information according to operation of the electronic device on a partial portion or the whole portion of a screen. The output unit 940 may output information generated according to control of the control unit 910.

The control unit 910 includes the output control unit 912 for controlling an output of the electronic device according to an embodiment of the present invention. For example, the control unit 910 may perform control such that the electronic device operates as illustrated in FIGS. 2, 4, 6 and 8. An operation of the control unit 910 according to an embodiment of the present invention will be described as follows.

The control unit 910 collects information through the detecting unit 920, the storage unit 930, or an external network. It is possible to collect information on an environment, such as the current time, a current illumination through the illumination detecting module, weather at the current time or a specific time, or news, and information on the user's schedule which is previously input by the user, a time until an alarm time point, or the like. The control unit 910 determines a control according to a previously-input operation condition. In order words, the control unit 910 determines output contents (control value). Specifically, when at least one of the collected information satisfies a preset condition, the control unit 910 determines an output according to the condition and controls the output unit 940 according to a result of the determination.

According to the embodiments of the present invention, it is possible to use the electronic device for a light service or an information provision service by detecting a user state using the detecting unit of the electronic device and controlling the electronic device, thereby expanding the functionality of the electronic device in addition to the original functionality of the electronic device. Also, it is possible to provide a stable and convenient service by detecting information of the user and automatically performing operation of the electronic device.

In the embodiments of the present invention, the components included therein may be expressed in a singular form or a plural form depending on the embodiments. The expressions of the singular form or the plural form have been properly selected depending on a situation for convenience of description. The present invention is not limited to a singular component or plural components. Any components expressed in the singular form herein are meant to also include the plural form and vice versa.

Embodiments of the present invention according to the claims and description in the specification can be realized in the form of hardware, software or a combination of hardware and software.

Such software may be stored in a non-transitory computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, devices or integrated circuits or on an optically or magnetically readable medium such as, for example, Compact Disc (CD), Digital Video Disc (DVD), magnetic disk, magnetic tape, or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the invention is defined not by the detailed description of the invention but by the appended claims, and all differences within the scope will be construed as being included in the present invention.

What is claimed is:

1. An electronic device comprising:
an output unit configured to output contents; and
a control unit configured to control the output of the contents based on at least one of a user state and an environment state.

2. The electronic device of claim 1, further comprising:
a detecting unit configured to detect the user state and the environment state.

3. The electronic device of claim 2, wherein the detecting unit comprises at least one of a motion detecting module configured to detect the user state, a sound detecting module configured to detect the user state, an illumination detecting module configured to detect the environment state, and a user identifying module configured to identify a user.

4. The electronic device of claim 2, wherein the detecting unit comprises a camera, and
wherein the camera is configured to detect at least one of a motionless state of the user and movement of the user.

5. The electronic device of claim 2, wherein the detecting unit comprises a microphone, and
wherein the microphone is configured to detect at least one of a sound of the user and a sound due to movement of the user.

6. The electronic device of claim 2, wherein the detecting unit comprises an illumination sensor configured to detect an ambient brightness.

7. The electronic device of claim 1, wherein the contents include at least one of a set alarm time point, current weather, news and information set by a user.

8. The electronic device of claim 1, wherein the output unit comprises a screen, and
wherein the control unit is further configured to control a turn-on or turn-off operation for at least one of the screen and a portion of the screen.

9. The electronic device of claim 1, wherein the contents comprises screen brightness, and
wherein the screen brightness is controlled according to an ambient environment by using information acquired from a detecting unit.

10. The electronic device of claim 8, wherein the control unit is further configured to control such that the screen is automatically turned on when motion of a user is detected.

11. The electronic device of claim 1, wherein the control unit is further configured to display the contents corresponding to a user after identifying the user.

12. The electronic device of claim 11, wherein the contents corresponding to the user includes at least one of a schedule of the user, a preset alarm time point, current weather, news and information set by the user.

13. The electronic device of claim 1, wherein the control unit is further configured to control one of a sleep inducing mode and a sleep preventing mode, which is set by a user, when it is determined that the user is sleeping.

14. The electronic device of claim 13, wherein, when the sleep inducing mode is performed, the control unit is further configured to perform at least one of reducing a screen brightness of the electronic device, turning off a screen, and reducing a volume.

15. The electronic device of claim 13, wherein, when the sleep preventing mode is performed, the control unit is further configured to perform at least one of increasing a screen brightness of the electronic device, displaying a glittering effect, and increasing a volume.

16. A method for an electronic device, the method comprising:
controlling an output of contents based on at least one of a user state and an environment state; and
outputting the contents.

17. The method of claim 16, further comprising:
detecting the user state and the environment state.

18. The method of claim 17, wherein detecting the user state and the environment state includes at least one of detecting a motion for detecting the user state, detecting a sound for detecting the user state, detecting an illumination for detecting the environment state, and identifying a user.

19. The method of claim 18, wherein detecting the motion includes identifying at least one of a motion of the user, a sleep state of the user, and the user by using a camera.

20. The method of claim 18, wherein detecting the sound includes identifying at least one of a motion of the user, the user state, and the user by using a microphone.

21. The method of claim 18, wherein detecting the illumination includes detecting an ambient brightness by using an illumination sensor.

22. The method of claim 16, wherein the contents include at least one of a preset alarm time point, current weather, news and information set by a user.

23. The method of claim 16, wherein controlling the output includes controlling a turn-on or turn off operation for at least one of a screen and a portion of the screen.

24. The method of claim 16, wherein controlling the output includes controlling a screen brightness according to an ambient environment by using information acquired from detecting the environment state.

25. The method of claim 23, wherein controlling the output includes controlling such that the screen is automatically turned on when a motion of a user is detected.

26. The method of claim 16, wherein controlling the output includes controlling to provide the contents corresponding to a user after identifying the user.

27. The method of claim 26, wherein the contents corresponding to the user includes at least one of a schedule of the user, a preset alarm time point, current weather, news and information set by the user.

28. The method of claim 16, wherein controlling the output includes controlling according to at least one of a sleep inducing mode and a sleep preventing mode, which is set by a user, when it is determined that the user is sleeping.

29. The method of claim 28, wherein, when the sleep inducing mode is performed, controlling the output includes reducing a screen brightness of the electronic device, turning off a screen, and reducing a volume.

30. The method of claim 28, wherein, when the sleep preventing mode is performed, controlling the output includes increasing a screen brightness of the electronic device, displaying a glittering effect, and increasing a volume.
